(19) United States
(12) Patent Application Publication
(10) Pub. No.: US 2009/0007170 A1
(43) Pub. Date: Jan. 1, 2009

(54) System and method for monitoring a real time event

(75) Inventors: Dortha Everitt, Cedar Park, TX (US); Abdul Jabali, Cedar Park, TX (US); Jeremy Dennehy, Leander, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: AT&T KNOWLEDGE VENTURES, LP, Reno, NV (US)

(21) Appl. No.: 11/768,767

(22) Filed: Jun. 26, 2007

(51) Int. Cl. H04N 7/173

(52) U.S. Cl. 725/32; 348/588; 725/100; 725/87

(57) ABSTRACT

An apparatus includes a trigger module and a tuning module. The trigger module presents a notification on a display device in connection with an occurrence of a predetermined condition in a real time event, such that the notification is added to a decoded video signal representing a video presentation other than the real time event before the decoded video signal is output to the display device. The tuning module displays the real time event when the notification is selected. A method for presenting a notification for an occurrence of a predetermined condition in a real time event and for displaying the real time event is also disclosed.

### FIELD OF THE DISCLOSURE

This invention generally relates to managing television information.

### BACKGROUND

Television viewing is a popular form of entertainment. Developments in television and video technologies allow viewers to watch a wide variety of high-resolution content and to record programs to watch at a convenient time. Recent advancements, such as video-on-demand and the expansion of available channels, add to the breadth and convenience of television programming. Viewers have considerable freedom to determine and schedule the types of programming content to watch.

With all the choices that television audiences face, few viewers are likely to enjoy everything. Thus, managing television information is an important aspect of television viewing. Because service providers offer television channels in packages, many users configure their televisions to display certain channels. Viewers may simply be disinterested in some channels, or they may consider channels inappropriate for display to children.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of an Internet protocol television (IPTV) system;

FIG. 2 is a block diagram of a video monitoring system;

FIG. 3 is an embodiment of the video monitoring system;

FIG. 4 is an embodiment of a program user for the video monitoring system;

FIG. 5 is an embodiment of a user interface for setting a predetermined condition;

FIG. 6 is a flow chart of a method of delivering notifications over the IPTV system;

FIG. 7 is a flow chart of a method of receiving notifications over the IPTV system;

FIG. 8 is a flow chart of a method for monitoring multiple channels; and

FIG. 9 is a flow chart of a method for setting the predetermined conditions.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

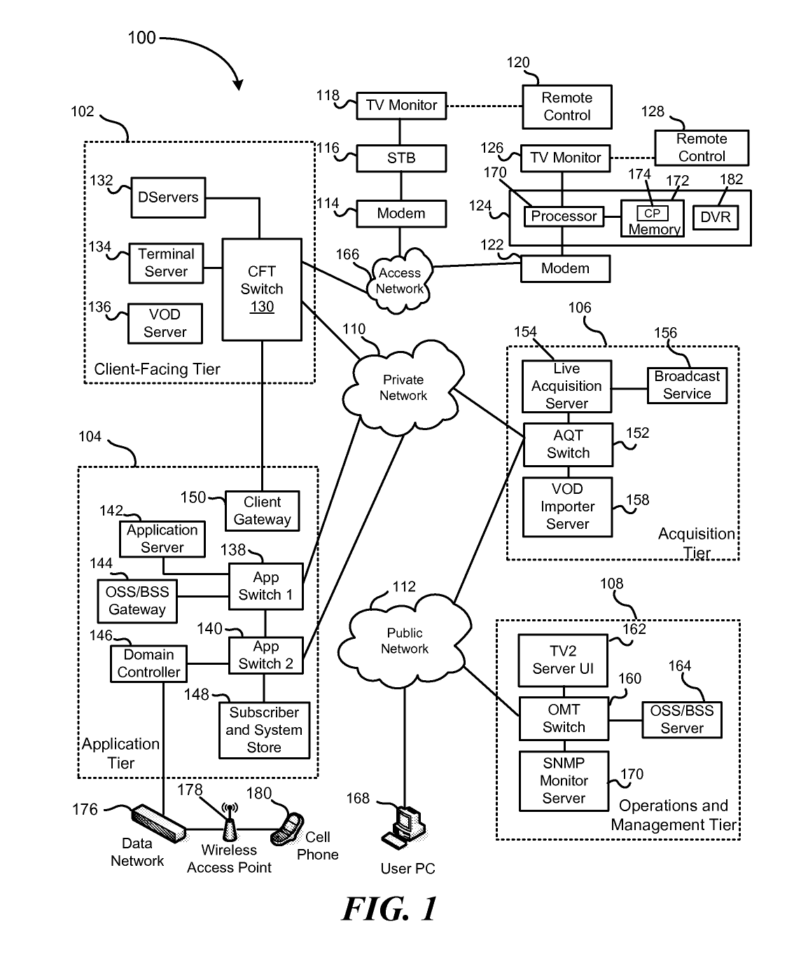

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to a public network such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include an STB processor 170 and an STB memory device 172 that is accessible to the STB processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer 168 coupled to the public network 112.

The domain controller 146 communicates with the public network 112 via the second APP switch 140. Additionally, the domain controller 146 can communicate via the public network 112 with the personal computer 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 180.

In a particular embodiment, the set-top box devices can include an STB computer program 174 that is embedded within the STB memory device 172. In a particular embodiment, the STB computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating second set-top box device with a user account, or with any combination of these.

The STB computer program 174 can contain instructions to receive many types of user preferences from the domain controller 146 via the access network 166. For example, the STB computer program 174 can include instructions to receive a request to record at least one television program at a digital video recorder (DVR) 182 within the second set-top box device 124. In this example embodiment, the STB computer program 174 can include instructions to transmit the request to the DVR 182, where the television program(s) are recorded. In an illustrative embodiment, the STB computer program 174 can include instructions to receive from the DVR 182 a recording status with respect to one or more of the television programs and to transmit at least one message regarding the status to a wireless device such as the cellular phone 180. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular phone 180. In an illustrative embodiment, the status can be sent via a wireless access protocol (WAP). Further details of the IPTV system are taught in U.S. Patent Application Publication No. 2007/0083895, the disclosure of which is hereby incorporated by reference.

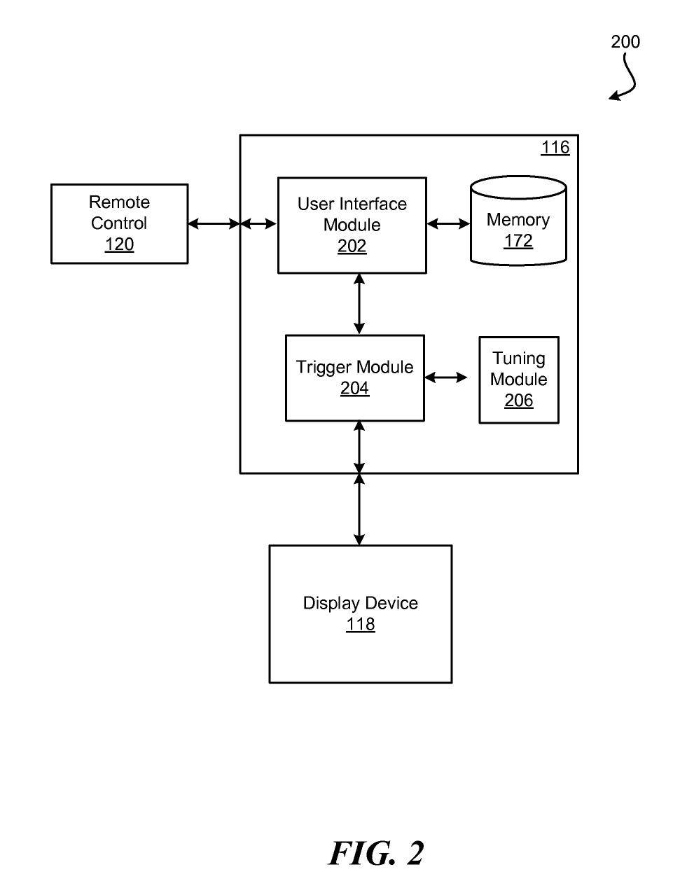

FIG. 2 shows a block diagram of a video monitoring system 200 including a video receiver such as the set-top box 116, the display device 118, and the remote control 120. The set-top box includes the memory 172, a user interface module 202, a trigger module 204, and a tuning module 206. The user interface module 202 is coupled to the memory 172 and the trigger module 204. The trigger module 204 accesses the memory 172 to retrieve information stored in the memory by the user interface module 202.

The user interface module 202 receives a control stimulus from a user of the remote control 120, and sets a predetermined condition for a real time event based on the control stimulus received. The predetermined condition selected by the user with the control stimulus is stored on the memory 172 for later access by the trigger module 204. The trigger module 204 retrieves the predetermined condition stored in the memory 172. The predetermined condition may additionally be stored on a monitoring device, such as the server 154 (FIG. 1), and the server monitors a real time event for the predetermined condition. Upon detecting the predetermined condition, the server 154 sends a notification to the set-top box 116, and the trigger module receives the notification from the server.

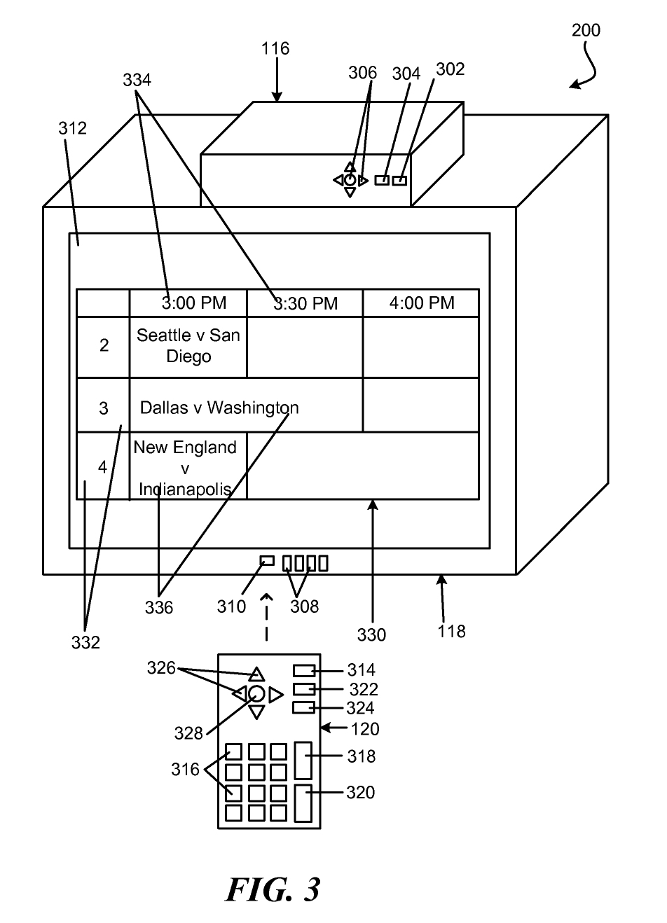

FIG. 3 shows an embodiment of the video monitoring system 200 including the set-top box 116, the remote control 120, and the display device 118. The exterior of the set-top box 116 includes an infrared sensor 302, a power button 304 and a plurality of control buttons 306. The display device 118 is preferably a television including a plurality of control buttons 308, an infrared sensor 310, and a display screen 312. The remote control 120 is preferably a remote control including a power button 314, a plurality of number buttons 316, a channel select button 318, a volume select button 320, a guide button 322, an event button 324, a plurality of control arrow buttons 326, and a select button 328.

The infrared sensor 302 of the set-top box 116 receives control stimulus from an external device and controls the set-top box based on the control stimulus received. The power button 304 of the set-top box 116 allows a user to turn the set-top box on or off, and the control buttons 306 allow the user to perform necessary operations on the set-top box. The power button 314 on the remote control 120 allows a user to turn different devices on and off, such as the display device 118 and the set-top box 116. A user is able to enter the number of a particular channel with the plurality of number buttons 316. The channel select button 318 allows the user to increment or decrement the channel displayed on the display screen 312, and the volume select button 320 changes the volume outputted from the display device 118. The guide button 322, the event button 324, the plurality of control arrow buttons 326, and the select button 328 perform a variety of control operations with the set-top box 116 which are discussed below.

The control buttons 308 of the display device 118 preferably include a power button, a channel button, a select button, and a menu button. The control buttons 308 allow the user to change the channel displayed on the display screen 312 and the volume of the audio from the display device 118 without the aid of an additional device such as the remote control 120. The display screen 312 is able to display video signals from various sources such as the set-top box 116, a digital video disc (DVD) player, and an analog antenna. The infrared sensor 310 receives control stimulus from an external device and controls the display device 118 based on the control stimulus received.

When the guide button 322 of the remote control 120 is pressed, a program guide 330 is displayed on the display screen 312 of the display device 118. The program guide 330 includes a plurality of channel numbers 332, a plurality of viewing times 334, and a plurality of programs 336. The channel numbers 332 are listed in a column on the left side of the program guide 330 and the viewing times 334 are listed in a row on the top of the program guide. The user is able to determine when and on what channel a program is shown by looking at the programs 336, which are under the viewing times 334 and to the right of the channel numbers 332. The user highlights the programs 336 by scrolling through the program guide 330 with the control arrow buttons 326 of the remote control 120 or the control buttons 306 on the set-top box 116. When a program 336 is highlighted, the user is able to view the program by pressing the select button 334 on the remote control 120, or set a predetermined condition for the program 336 highlighted by pressing the event button 324.

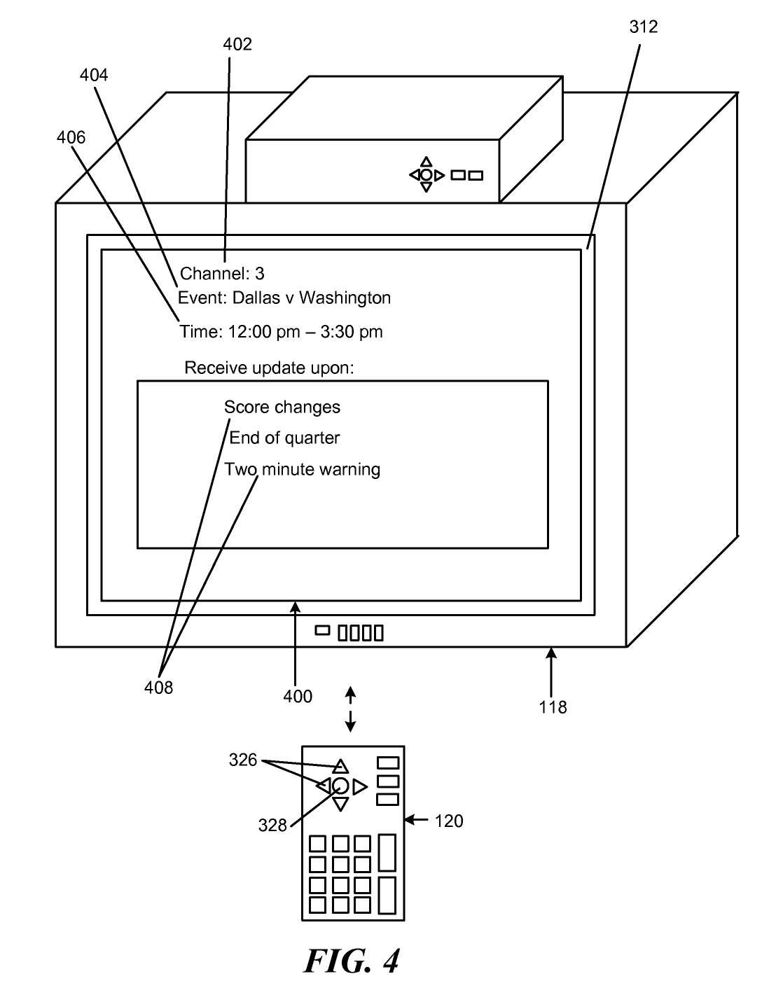

FIG. 4 shows a graphical user interface (GUI) 400 displayed on the display screen 312 of the display device 118. The GUI 400 includes a channel indicator GUI element 402, a real time event GUI element 404, a time slot GUI element 406, and a plurality of GUI elements representing predetermined conditions 408. The channel indicator GUI element 402, the real time event GUI element 404, and time slot GUI element 406 are displayed to verify the channel, event, and time to be monitored for the predetermined condition 408 selected. The user selects from the predetermined conditions 408 when an update is to be given. For example, in a sporting event, the predetermined conditions 408 may include a score change, an end of a quarter, a ninth inning, a two-minute warning, a knock-down, a final lap, a touchdown, and a home run. If the real time event is a stock market trading event, the predetermined condition is preferably a stock price reaching a predetermined amount. The stock market trading event is preferably any event involving the trading of stocks such as a buy or a sell of a stock.

The user scrolls through the predetermined conditions 408 by pressing the up and/or down arrows of the control arrow buttons 326 on the remote control 120. As the user scrolls through the predetermined conditions 408, the current predetermined condition is highlighted on the graphical user interface400. The user selects a predetermined condition 408 by pressing the select button 328 on the remote control 120. The display screen 312 returns to the program guide 330 and the user has the option to select another channel, or program for a real time event on which to set the predetermined condition 408.

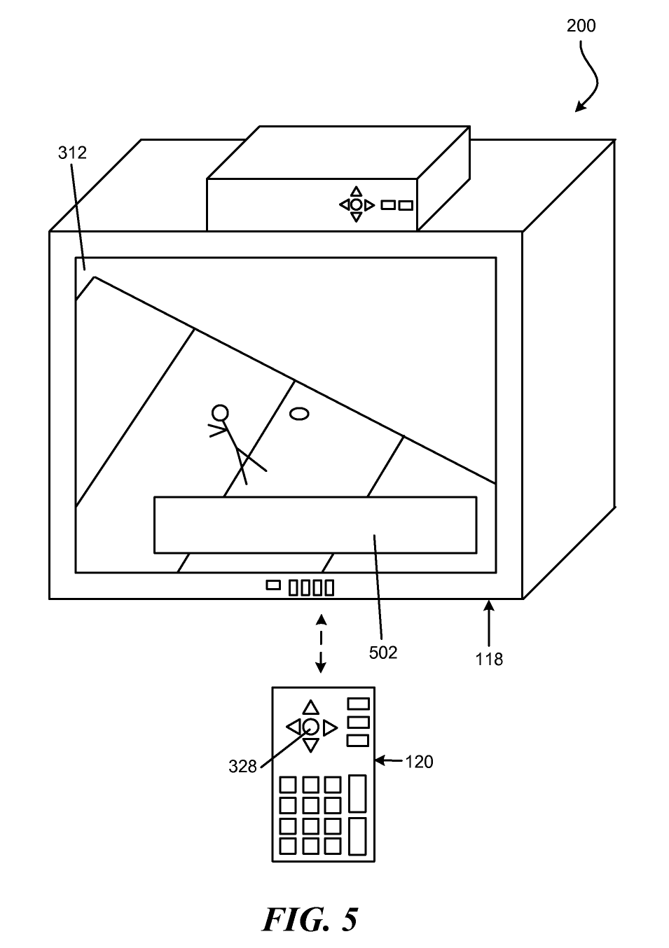

FIG. 5 shows the video monitoring system 200 during the display of a video channel. The display device 118 receives a decoded moving picture experts group (MPEG) video stream and/or signal from the set-top box 116 and displays the picture on the display screen 312. A pop-up notification 502 appears on the display screen 312 during the viewing of a decoded video signal by the user. The pop-up notification 502 is added to the decoded video signal representing a video presentation other than the real time event before the decoded video signal is outputted to the display device. The pop-up notification 502 informs the user that a predetermined condition has occurred in the real time event monitored by the monitoring device such as the server 154 (FIG. 1). If the user does not select the pop-up notification 502 within a pre-determined amount of time after the pop-up notification is displayed, the pop-up notification is no longer displayed and the current channel continues to be displayed. However, if the user selects the pop-up notification, preferably by pressing the select button 328 on the remote control 120, the tuning module 206 (FIG. 2) tunes to a video channel and displays a video stream representing the real time event on the display device 118. The real time event may be displayed by the current display of the display device being substituted for the real time event or the real time event may be displayed as a picture-in-picture (PIP) display. If the real time event is the sporting event, the output is preferably changed to a video presentation representing the sporting event. If, however, the real time event is the stock market trading event, the output is preferably changed to a financial news broadcasting station.

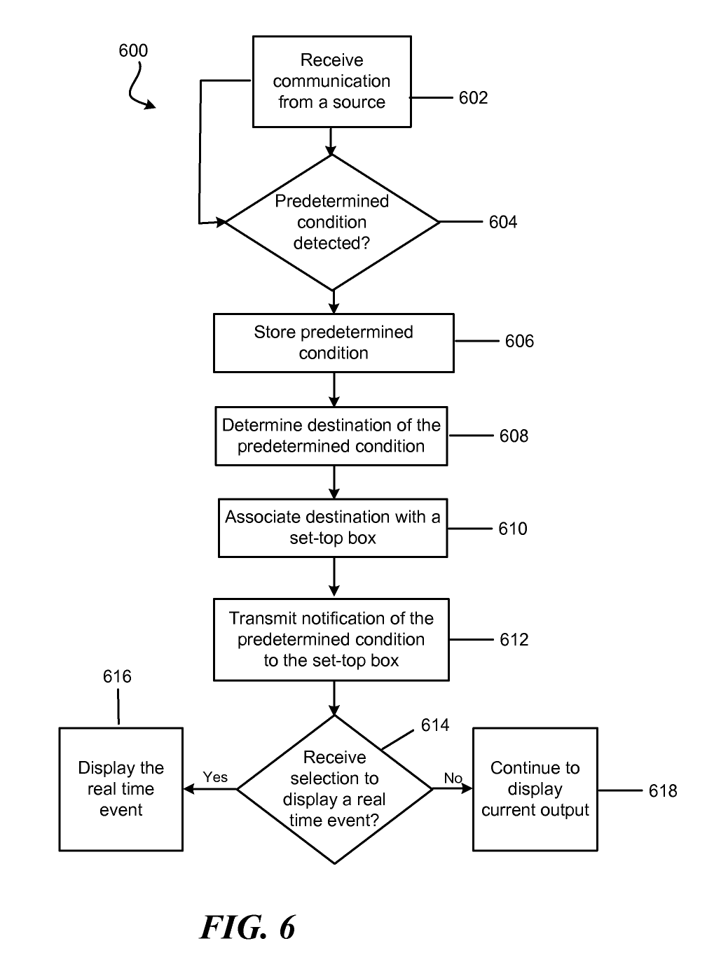

Referring to FIG. 6, a method 600 of delivering notifications is shown. At block 602, a server within an Internet Protocol Television (IPTV) system receives a communication from a source device. A communication can include, for example, a predetermined condition, that is issued from a source device outside the IPTV system. In a particular embodiment, the communication can be received at the server via a public network, such as the Internet, a public switched telephone network (PSTN), a plain old telephone service (POTS) network, or an Internet Protocol (IP) phone network. In another embodiment, the communication can be a message received from a set-top box device that communicates with the server via the IPTV system.

At block 604, a determination is made as whether a predetermined condition is detected at the server. If it is determined that the predetermined condition is detected, the method continues to block 606, and the predetermined condition can be stored in a memory portion at the server or at a device coupled to the server. Moving to block 608, the destination of the predetermined condition is determined at the server. Continuing to block 610, the server associates the destination with a set-top box device. In an illustrative embodiment, the server can communicate with an information store, such as the subscriber and system store shown in FIG. 1, which contains user account information associating various set-top box devices with various destinations. For instance, the information store can relate data associated with destination devices, such as an IP address of a user computer with data relating to the set-top box device, such as an IP address of the set-top box device, data associated with one or more twisted pairs connected with the set-top box device, data associated with one or more fiber optic cables coupled to the set-top box device, an alphanumeric identifier of the set-top box device, any other data that is suitable for associating a set-top box device with a user account, or any combination of these.

At block 612, a notification of the predetermined condition is transmitted from the server to the set-top box device via a private network within the IPTV system. In a particular embodiment, the notification can be transmitted from the set-top box device to a display device, such as a television monitor. The notification can include any information suitable for notifying the user that predetermined condition has been detected. For example, the notification can include a channel number associated with the predetermined condition, a program title, a real time event name, a description of the predetermined condition, or any combination of these. One example of predetermined condition notification is disclosed with reference to FIG. 5.

At block 614, a selection display the real time event associated with the predetermined condition can be received at the server from the set-top box device. In an illustrative embodiment, a user can issue a command to the set-top box device via a remote control to select the notification and to display the real time event associated with the predetermined condition, and the command can be transmitted to the server. If the server receives a command to display a channel associated with the real time event and the predetermined condition, the method proceeds to block 616, and the set-top box device displays the channel associated with the real time event to the user. At block 618, if such a command is not received at the server the real time event is not displayed.

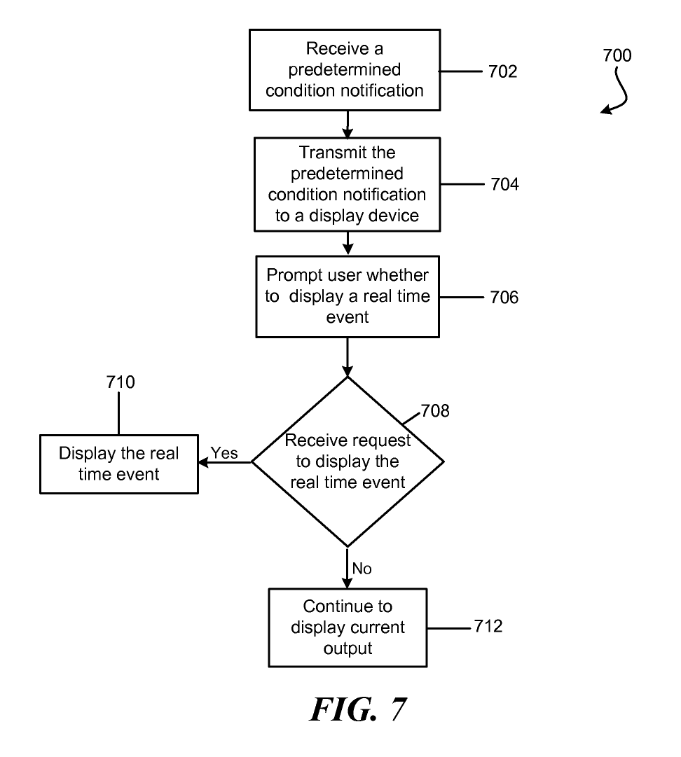

Referring to FIG. 7, a method 700 of receiving notifications is shown. At block 702, a notification of a predetermined condition is received at a set-top box from a server. The set-top box can receive the notification from the server via a private network within an IPTV system. The notification can be associated with a communication from a source device outside the IPTV system to a destination outside the IPTV system.

At block 704, the set-top box transmits the predetermined condition notification to a display device. The notification can include any information suitable for notifying the user that predetermined condition has been detected. For example, the notification can include a channel number associated with the predetermined condition, a program title, a real time event name, a description of the predetermined condition, or any combination of these.

At block 706, the user can be prompted to determine whether or not to display the real time event associated with the predetermined condition on the display device. In one embodiment, a command display the real time event can be received from a user via a remote control device that communicates with the set-top box device. The command can be issued by selecting soft buttons on the pop-up notification or by pressing designated keys on the remote control. At block 708, a determination is made as to whether or not a command to display the real time event is received. If the set-top box receives the command not to display the real time event, the method proceeds to block 710 and does not display the real time event. Conversely, if the set-top box device receives a command to display the real time event, the set-top box device transmits the channel associated with the real time event and the predetermined condition to a display device at block 712.

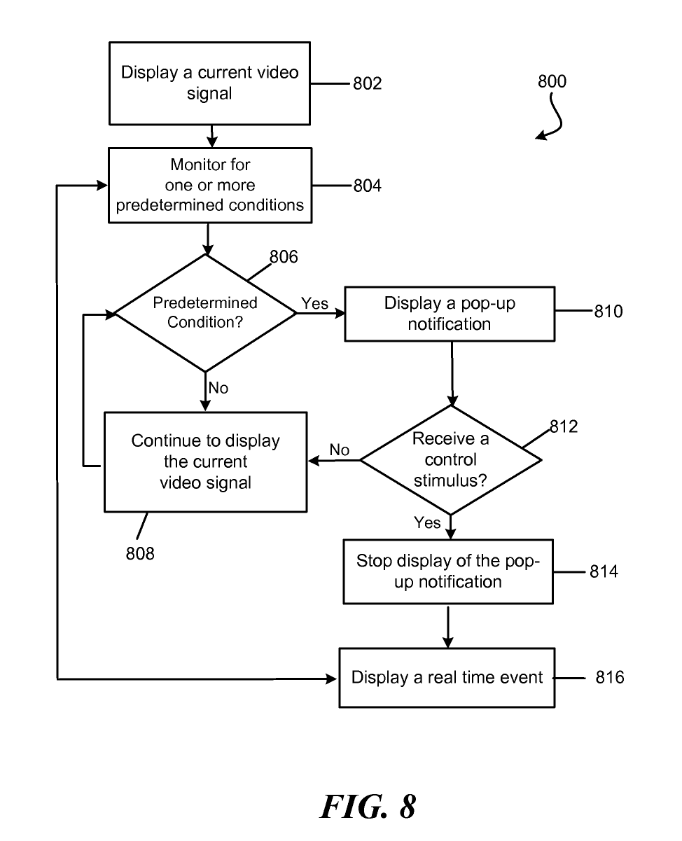

FIG. 8 shows a flow chart of a method 800 for monitoring multiple video channels at the same time. A current video signal is displayed at block 802. The first video channel is sent from a set-top box to a display device such as a television. At block 804, one or more real time events are monitored. A trigger module of the set-top box waits for one or more predetermined conditions to be detected in the real time events at block 806. The predetermined conditions may include a score change, an end of a quarter, a ninth inning, a two-minute warning, a knock-down, a final lap, a touchdown, a home run, a stock price reaching a pre-determined amount, and a breaking new story. At block 808, if the trigger module does not detect a signal indicating the occurrence of the predetermined condition, the current video signal is continually displayed. If the predetermined condition is detected, a pop-up notification is displayed at block 810. The pop-up notification is preferably displayed over the current video signal displayed on the display device with the current video signal visible in the background. At block 812, the user interface module searches for a control stimulus from a remote control. If the control stimulus is not detected, the pop-up notification is no longer displayed and the display device resumes regular display at block 808. If the control stimulus is received, the pop-up notification is no longer displayed at block 814. At block 816, a real time event is displayed. The real time event is associated with the pop-up notification such as a sporting event, a business news channel, or a news network channel. The trigger module continues to monitor for the occurrence of a predetermined condition at block 804.

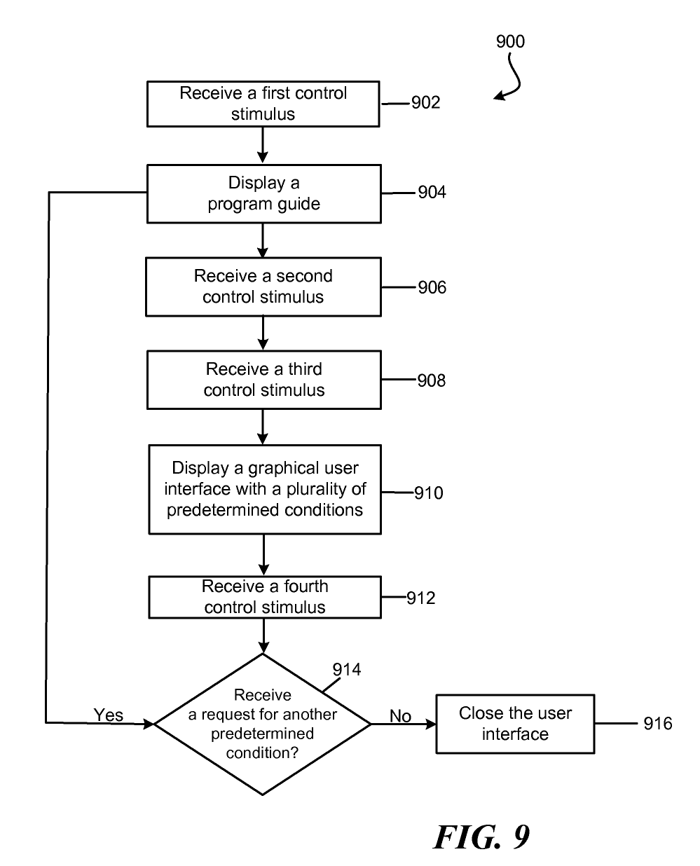

FIG. 9 shows a flow chart of a method 900 for setting one or more predetermined conditions in a channel monitoring system. At block 902, a first control stimulus is received. The first control stimulus is preferably a guide button on a remote control of the user. A program guide is displayed at block 904. The program guide displays the channels and viewing times for the different programs of real times events offered. At block 906, a second control stimulus is received. The second control stimulus preferably highlights a particular program in the program guide. A third control stimulus is received at block 908. The third control stimulus is preferably an event button on the remote control. At block 910, a graphical user interface is displayed with a plurality of predetermined conditions for the program highlighted at block 906. At block 912, a fourth control stimulus is received. The fourth control stimulus preferably selects a predetermined condition for the real time event. At block 914, a determination is made as to whether a request for another predetermined condition is received. If the request is received, the program guide is again displayed at block 906 and the method continues as stated above. If the request is not received, the user interface is closed at block 918.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. An apparatus comprising:
a trigger module configured to present of a notification on a display device in connection with an occurrence of a predetermined condition in a real time event, such that the notification is added to a decoded video signal representing a video presentation other than the real time event before the decoded video signal is output to the display device; and
a tuning module configured to display the real time event when the notification is selected.

2. The apparatus of claim 1 wherein the real time event is displayed as a picture-in-picture display.

3. The apparatus of claim 1 wherein the video presentation is substituted for the display of the real time event.

4. The apparatus of claim 1 wherein selection of the notification is based on a control stimulus received by the tuning module.

5. The apparatus of claim 1 wherein the notification is a pop-up notification.

6. The apparatus of claim 1 wherein the output of the display device is changed by tuning to a video channel and decoding a moving picture experts group video stream.

7. The apparatus of claim 1 further comprising:
a graphical user interface configured to allow a user to identify the predetermined condition in the real time event, the graphical user interface including a graphical user interface element representing the real time event and a plurality of additional graphical user interface elements representing a predetermined condition selected from a group consisting of a ninth inning, a two-minute warning, a knock-down, a final lap, a touchdown, and a home run.

8. A method comprising:
presenting a notification on a display device in connection with an occurrence of a predetermined condition in a real time event; and
displaying the real time event when the notification is selected.

9. The method of claim 8 wherein the real time event is a sporting event.

10. The method of claim 9 wherein the predetermined condition is the sporting event reaching a predefined in-game moment selected from a group consisting of a ninth inning, a two-minute warning, a knock-down, a final lap, a touchdown, and a home run.

11. The method of claim 8 wherein the real time event is displayed as a picture-in-picture display.

12. The method of claim 8 wherein a current display is substituted for the display of the real time event.

13. The method of claim 8 wherein the notification is a pop-up notification.

14. The method of claim 8 further comprising:
receiving a control stimulus for a selection of the notification.

15. A system comprising:
a monitoring device configured to monitor a real time event for a predetermined condition; and
a video receiver in communication with the monitoring device, the video receiver configured to output a notification of the predetermined condition and to display the real time event when the notification is selected.

16. The system of claim 15 wherein the notification is a pop-up notification.

17. The system of claim 15 wherein the real time event is displayed as a picture-in-picture display.

18. The system of claim 15 wherein a current display is substituted for the display of the real time event.

19. The system of claim 15 wherein the video receiver is a set-top box.

20. The system of claim 15 wherein the selection of the notification is based on a control stimulus received by the video receiver.
